(19) United States
(12) Patent Application Publication
(10) Pub. No.: US 2009/0286047 A1
(43) Pub. Date: Nov. 19, 2009

(54) SEMICONDUCTOR WAFER

(75) Inventor: Yasunori YAMADA, Tokyo (JP)

Correspondence Address: GREENBLUM & BERNSTEIN, P.L.C., 1950 ROLAND CLARKE PLACE, RESTON, VA, 20191, US

(73) Assignee: SUMCO CORPORATION, Tokyo (JP)

(21) Appl. No.: 12/465,756

(22) Filed: May 14, 2009

(30) Foreign Application Priority Data
May 15, 2008 (JP) 2008-128912

(51) Int. Cl. B32B 3/02

(52) U.S. Cl. 428/192

(57) ABSTRACT

A semiconductor wafer includes front and back side-chamfered surfaces asymmetric to each other with respect to a virtual line extending in a diametrical direction as the center, at half: the height of the outer edge surface. In addition, the height of the front side-chamfered surface is greater than that of the back side-chamfered surface, causing the front side-chamfered portion to be thicker than the back side-chamfered portion, thereby increasing the number of wafer reclamation cycles.

### CROSS-REFERENCE TO RELATED APPLICATIONS

The present application claims priority under 35 U.S.C. §119 of Japanese Application No. 2008-128912, filed on May 15, 2008, the disclosure of which is expressly incorporated by reference herein in its entirety.

### BACKGROUND OF THE INVENTION

1. Field of the Invention

The present invention relates to semiconductor wafers, more specifically to a semiconductor wafer capable of increasing the number of reclamation cycles.

2. Description of Related Art

In device formation, various inspections are performed in a variety of important processes by using test wafers manufactured from the same ingot that product silicon wafers are manufactured from, the product silicon wafers being shipped from a wafer manufacturing facility. In the device formation, defective wafers are generated in each process, which amount to approximately 30% of the entire wafers processed therein. These test wafers and defective wafers, instead of being discarded, are normally delivered to a reclamation line. Having undergone the reclamation processing, these wafers become reclaim polished wafers that are equivalent to new wafers. Such wafer reclamation is more frequent with wafers having a larger diameter, such as silicon wafers having 450 mm in diameter and the like.

Silicon wafers that are to reclaim material vary in type, and the examples include bare wafers, wafers having an oxide film, wafers having a nitrogen film, wafers having a polysilicon film, diffused wafers, epitaxial wafers, resist-coated wafers, metal-coated wafers, patterned wafers, wafers having a multi-layer film, and the like. In the reclamation processes, silicon wafers received as reclaim material undergo a receiving inspection such as separation by film type, an inspection for appearance, and the like. Then, the silicon wafers sequentially undergo grinding of the front surface (a device forming surface), mirror-polishing of the wafer chamfered surfaces, and mirror-polishing of the front surface.

In the chamfered portions (outer peripheral portions) of a conventional silicon wafer that is to be reclaim material, the front and back side-chamfered surfaces are symmetric to each other when viewed in a cleavage plane that orthogonally intersects with the front and back surfaces of the silicon wafer. In addition, the front and back side-chamfered surfaces are the same in height (refer to Japanese Patent Laid-open Publication No. H11-207585). In other words, the front and back side-chamfered portions of the silicon wafer are the same in thickness.

As described above, the front and back side-chamfered portions of the conventional silicon wafer that is to be reclaim material are the same in thickness. Therefore, as the number of reclamation cycles of the silicon wafer increases, the thickness of the front side-chamfered portion is reduced in the grinding processes in each reclamation cycle, which therefore allows only one or two cycles of reclamation. Such chamfering of the front surface side of the wafer is effective in preventing chipping of the outer peripheral portions of the wafer in the polishing processes or cracking of the wafer in the device forming processes. For this reason, the chamfering is considered an important process in manufacturing wafers.

### SUMMARY OF THE INVENTION

The inventor of the present invention conducted intensive studies and found that the number of reclamation cycles of a semiconductor wafer can be increased as described below compared to that of conventional silicon wafers. According the finding, the semiconductor wafer has an outer edge surface orthogonally intersecting with front and back surfaces and front and back side-chamfered surfaces. When viewed in a cleavage plane orthogonally intersecting with the front and back surfaces of the silicon wafer, the front and back side-chamfered surfaces are asymmetric to each other with respect to a virtual line extending in a diametrical direction of the silicon wafer as the center, at half the height of the outer edge surface. In addition, the height of the front side-chamfered surface is larger than that of the back side-chamfered surface. Thereby, the present invention is achieved.

A non-limiting advantage of the present invention provides a semiconductor wafer capable of increasing the number of reclamation cycles.

According to a first feature of the present invention, a semiconductor wafer has an outer edge surface orthogonally intersecting with front and back surfaces and configuring an outermost peripheral edge; a front side-chamfered surface connecting the outer edge surface to the front surface; and a back side-chamfered surface connecting the outer edge surface to the back surface. When viewed in a cleavage plane orthogonally intersecting with the front and back surfaces of the semiconductor wafer, the front and back side-chamfered surfaces are asymmetric to each other with respect to a virtual line extending in a diametrical direction of the semiconductor wafer as the center, at half a height of the outer edge surface. In addition, a height of the front side-chamfered surface is greater than a height of the back side-chamfered surface.

According to the first feature of the invention, when viewed in a cleavage plane (a cross-section) orthogonally intersecting with the front and back surfaces of the semiconductor wafer, the front and back side-chamfered surfaces are asymmetric to each other with respect to the virtual line extending in the diametrical direction of the semiconductor wafer as the center, at half the height of the outer edge surface. In addition, the height of the front side-chamfered surface is greater than that of the back side-chamfered surface. In other words, the front side-chamfered portion (an outer peripheral portion) is thicker than the back side-chamfered portion of the semiconductor wafer. Accordingly, the number of wafer reclamation cycles can be increased by the increased amount of the thickness of the front side-chamfered portion compared to that of conventional wafers.

Examples of the semiconductor wafer include monocrystalline silicon wafers, polycrystalline silicon wafers, and the like. The front surface of the silicon wafer is mirror-polished. A diameter of the semiconductor wafer is, for example, 200 mm, 300 mm, 450 mm, and the like. The larger the diameter of the wafer is, the higher a unit price of the wafer becomes, and hence the semiconductor wafer is reclaimed more frequently. “An outer edge surface orthogonally intersecting with front and back surfaces and configuring an outermost peripheral edge” refers to a circumferential surface of the semiconductor wafer (an outermost peripheral edge surface) in a cross-section orthogonally intersecting with the front and back surfaces of the semiconductor wafer and including a central axis of the semiconductor wafer.

“A height of the front side-chamfered surface” refers to a length between one end (a point where the front side-chamfered surface comes in contact with the outer edge surface) and the other end (a point where the front side-chamfered surface comes in contact with the front surface) of the front side-chamfered surface in a central axial direction of the semiconductor wafer in a cross-section including the central axis of the semiconductor wafer. “A height of the back side-chamfered surface” refers to a length between one end (a point where the back side-chamfered surface comes in contact with the outer edge surface) and the other end (a point where the back side-chamfered surface comes in contact with the back surface) of the back side-chamfered surface in a central axial direction of the semiconductor wafer in a cross-section including the central axis of the semiconductor wafer. The height of the chamfered surface is a distance (distance in the central axial direction of the wafer) between a point (line) at which the chamfered surface comes in contact with the outer edge surface and a point (line) at which the chamfered surface comes in contact with the front and back surfaces. “When viewed in a cleavage plane orthogonally intersecting with the front and back surfaces of the semiconductor wafer, . . . at half a height of the outer edge surface” refers to a position half the length of a straight line corresponding to the outer edge surface in a cross-section including the central axis of the semiconductor wafer. The outer edge surface orthogonally intersects with the front and back surfaces. The outer edge surface is identical to a side surface of a cylindrical body. The height of the outer edge surface is a vertical length in a cross-section perpendicular to the front and back surfaces. The height is a height of the cylindrical body. “The front and back side-chamfered surfaces are asymmetric to each other with respect to a virtual line extending in a diametrical direction of the semiconductor wafer as the center” refers to a condition in which, when the semiconductor wafer in a cross-section including the central axis thereof is hypothetically folded into portions of the front and back sides, along the virtual line orthogonally intersecting with the outer edge surface as the center, at half the length of the outer edge surface, the front and back side-chamfered surfaces do not exactly overlap each other (do not match each other). When a perpendicular bisector of a perpendicular line indicating the outer edge surface in a perpendicular cleavage plane of the wafer is a symmetrical axis, a curved shape indicating the front-side chamfered surface and a curved shape on the rear side are asymmetrical (curved lines do not match when folded).

“A height of the front side-chamfered surface is greater than a height of the back side-chamfered surface” refers to a condition in which the front side-chamfered portion is thicker than the back side-chamfered portion of the semiconductor wafer. The front and back side-chamfered surfaces may be a straight line or an arc when viewed in a cleavage plane orthogonally intersecting with the front and back surfaces of the semiconductor wafer. A “chamfered portion of the semiconductor wafer” refers a region in which the edge surface of the semiconductor wafer is chamfered.

A manufacturing method of the above-described semiconductor wafer is explained herein. Specifically, a wafer monocrystal pulled up according to the Czochralski method, for example, sequentially undergoes grinding of the outer periphery, cutting in blocks, and slicing, so that the semiconductor wafer is obtained. Then, the semiconductor wafer sequentially undergoes each process of chamfering, lapping, etching, and polishing.

In the chamfering process, a chamfering grindstone having an annular groove on an outer edge surface and rotating around a rotation axis is used. Annular groove-forming surfaces include three surfaces in a cross-section including the rotation axis: a depth surface shown in a straight line, an upper inclined surface gradually inclined upward and outward, and a lower inclined surface gradually inclined downward and outward. In chamfering, the semiconductor wafer is ground while the outer edge surface thereof is pressed against the depth surface of the chamfering grindstone, the front side-chamfered portion thereof is pressed against the upper inclined surface of the chamfering grindstone, and the back side-chamfered portion thereof is pressed against the lower inclined surface of the chamfering grindstone. Exemplary methods for reclaiming the semiconductor wafer includes a method in which a semiconductor wafer received as reclaim material sequentially undergoes a receiving inspection, such as separation by film type, an inspection for appearance, and the like; grinding of the front surface (a device forming surface); mirror-polishing of the outer peripheral surface; and mirror-polishing of the front surface.

According to a second feature of the present invention, a length of the front side-chamfered surface in a diametrical direction of the semiconductor wafer is longer than a length of the back side-chamfered surface in a diametrical direction of the semiconductor wafer.

“A length of the front side-chamfered portion in a diametrical direction of the semiconductor wafer” refers to the shortest distance (width) from an outer peripheral edge to an inner peripheral edge of the front side-chamfered portion when one faces the front surface. “A length of the back side-chamfered surface in a diametrical direction of the semiconductor wafer” refers to the shortest distance (width) from an outer peripheral edge to an inner peripheral edge of the back side-chamfered portion when one faces the back surface. For this case, an inclination angle of the front side-chamfered surface based on the front surface and an inclination angle of the back side-chamfered surface based on the back surface may or may not conform to each other.

According to third and fourth features of the present invention, an inclination angle of the front side-chamfered surface based on the front surface may be larger than an inclination angle of the back side-chamfered surface based on the back surface.

According to third and fourth features of the present invention, since the inclination angle of the front side-chamfered surface is larger than the inclination angle of the back side-chamfered surface, a flatness quality area of the front surface of the wafer can be expanded compared to conventional wafers regardless of the number of reclamation cycles.

The length of the front side-chamfered surface in a diametrical direction of the semiconductor wafer and the length of the back side-chamfered surface in a diametrical direction of the semiconductor wafer may or may not conform to each other.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is an enlarged longitudinal cross-sectional view of essential parts of a semiconductor wafer according to a first embodiment of the present invention;

FIG. 2 is an enlarged longitudinal cross-sectional view of essential parts of another semiconductor wafer according to the first embodiment of the present invention;

FIG. 3 is an enlarged longitudinal cross-sectional view of essential parts of another semiconductor wafer according to the first embodiment of the present invention;

FIG. 4 is an enlarged longitudinal cross-sectional view of essential parts of another semiconductor wafer according to the first embodiment of the present invention; and

FIG. 5 is an enlarged longitudinal cross-sectional view of essential parts of another semiconductor wafer according to the first embodiment of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

An embodiment of the present invention is described in detail hereinafter.

### First Embodiment

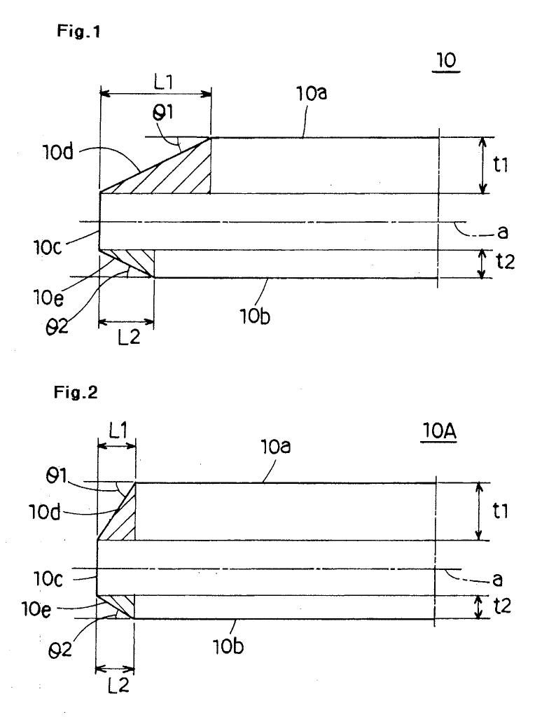

FIG. 1 shows a silicon wafer 10 (a semiconductor wafer) according to a first embodiment of the present invention. The silicon wafer 10 includes an outer edge surface 10c orthogonally intersecting with a front surface 10a and a back surface 10b and configuring an outermost peripheral edge, a front side-chamfered surface 10d connecting the outer edge surface 10c to the front surface 10a, and a back side-chamfered surface 10e connecting the outer edge surface 10c to the back surface 10b. When viewed in a cleavage plane that orthogonally intersects with the front surface 10a and back surface 10b of the silicon wafer 10, the front side-chamfered surface 10d and the back side-chamfered surface 10e are asymmetric to each other with respect to a virtual line a extending in a diametrical direction of the semiconductor wafer 10 as the center, at half a height of the outer edge surface 10c. In addition, a height t1 of the front side-chamfered surface 10d is greater than a height t2 of the back side-chamfered surface 10e. The silicon wafer 10 is a monocrystalline silicon wafer having 450 mm in diameter and the mirror-polished front surface 10a (a device forming surface).

A region in which chamfered portions of the silicon wafer 10 are formed is 1 mm from the outer edge surface 10c to a center in a diametrical direction of the silicon wafer 10. A length L1 of the front side-chamfered surface 10d in the diametrical direction of the silicon wafer 10 is 600 μm. An inclination angle θ1 of the front side-chamfered surface 10d based on the front surface 10a is 22°. A length L2 of the back side-chamfered surface 10e in the diametrical direction of the silicon wafer 10 is 500 μm. An inclination angle θ2 of the back side-chamfered surface 10e based on the back surface 10b is 22°. Specifically, the difference between the length L1 of the front side-chamfered surface 10d and the length L2 of the back side-chamfered surface 10e is 100 μm. In other words, the length L1 of the front side-chamfered surface 10d is 20% longer than the length L2 of the back side-chamfered surface 10e. The inclination angle θ1 of the front side-chamfered surface 10d is identical to the inclination angle θ2 of the back side-chamfered surface 10e.

In reclamation of the silicon wafer 10 used as, for example, a test wafer, the silicon wafer 10 received as reclaim material sequentially undergoes a receiving inspection, such as separation by film type, an inspection for appearance, and the like; grinding of the front surface 10a (a device forming surface); a PCR for mirror-polishing the chamfered surfaces 10c, 10d, and 10e ; and mirror-polishing of the front surface 10a. As described, in the first embodiment, when viewed in a cleavage plane that orthogonally intersects with the front surface 10a and back surface 10b of the silicon wafer 10, the front side-chamfered surface 10d and the back side-chamfered surface 10e are asymmetric to each other with respect to the virtual line a as the center. In addition, the height t1 of the front side-chamfered surface 10d is greater than the height t2 of the back side-chamfered surface 10e. In other words, the front side-chamfered portion is thicker than the back side-chamfered portion of the silicon wafer 10. Accordingly, the number of wafer reclamation cycles can be increased by the increased amount of the thickness of the front side-chamfered portion compared to that of conventional wafers.

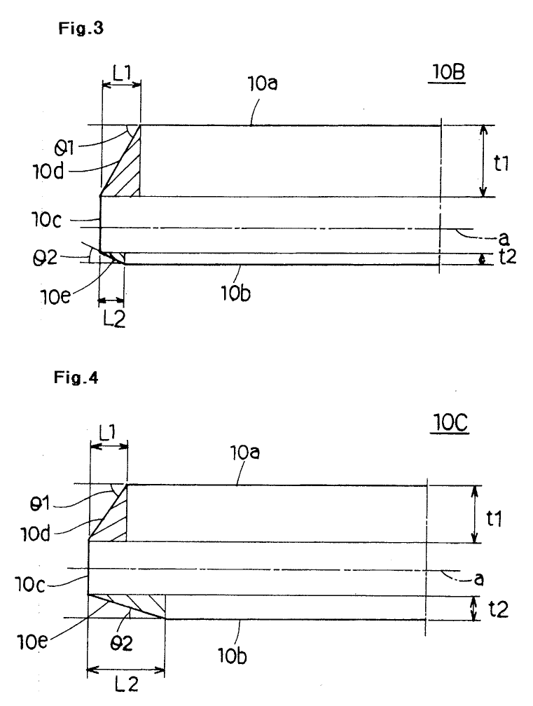

As a silicon wafer 10A shown in FIG. 2, the inclination angle θ1 of the front side-chamfered surface 10d may be larger than the inclination angle θ2 of the back side-chamfered surface 10e. At that time, the length L1 of the front side-chamfered surface 10d is identical to the length L2 of the back side-chamfered surface 10e. Alternatively, as a silicon wafer 10B shown in FIG. 3, the length L1 of the front side-chamfered surface 10d may be longer than the length L2 of the back side-chamfered surface 10e while the inclination angle θ1 of the front side-chamfered surface 10d is larger than the inclination angle θ2 of the back side-chamfered surface 10e.

In addition, as a silicon wafer 10C shown in FIG. 4, the length L1 of the front side-chamfered surface 10d may be shorter than the length L2 of the back side-chamfered surface 10e while the inclination angle θ1 of the front side-chamfered surface 10d is larger than the inclination angle θ2 of the back side-chamfered surface 10e. As described, since the inclination angle θ1 of the front side-chamfered surface 10d is larger than the inclination angle θ2 of the back side-chamfered surface 10e, the aforementioned mentioned effect of the first embodiment can be achieved even if the length L1 of the front side-chamfered surface 10d is shorter than the length L2 of the back side-chamfered surface 10e.

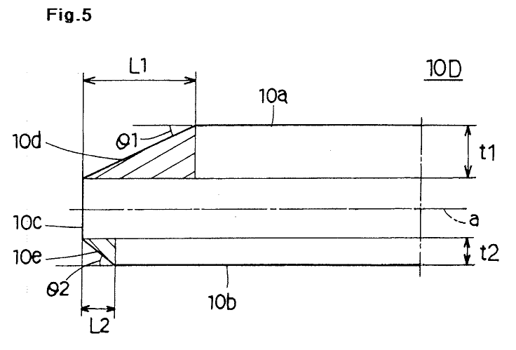

Furthermore, as a silicon wafer 10D shown in FIG. 5, the length L1 of the front side-chamfered surface 10d may be longer than the length L2 of the back side-chamfered surface 10e while the inclination angle θ1 of the front side-chamfered surface. 10d is smaller than the inclination angle θ2 of the back side-chamfered surface 10e.

The present invention is useful as a substrate wafer for such as bare wafers, wafers having an oxide film, wafers having a nitrogen film, wafers having a polysilicon film, diffused wafers, epitaxial wafers, resist-coated wafers, metal-coated wafers, patterned wafers, wafers having a multi-layer film, and the like. In addition, the present invention is useful as a test wafer for various types of processing in a variety of wafer manufacturing processes or device forming processes.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A semiconductor wafer comprising:
an outer edge surface orthogonally intersecting with front and back surfaces and configuring an outermost peripheral edge;
a front side-chamfered surface connecting the outer edge surface to the front surface; and
a back side-chamfered surface connecting the outer edge surface to the back surface;
wherein:
when viewed in a cleavage plane orthogonally intersecting with the front and back surfaces of the semiconductor wafer, the front and back side-chamfered surfaces are asymmetric to each other with respect to a virtual line extending in a diametrical direction of the semiconductor wafer as the center, at half a height of the outer edge surface; and
a height of the front side-chamfered surface is greater than a height of the back side-chamfered surface.

2. The semiconductor wafer according to claim 1, wherein a length of the front side-chamfered surface in a diametrical direction of the semiconductor wafer is longer than a length of the back side-chamfered surface in a diametrical direction of the semiconductor wafer.

3. The semiconductor wafer according to claim 1, wherein an inclination angle of the front side-chamfered surface based on the front surface is larger than an inclination angle of the back side-chamfered surface based on the back surface.

4. The semiconductor wafer according to claim 2, wherein an inclination angle of the front side-chamfered surface based on the front surface is larger than an inclination angle of the back side-chamfered surface based on the back surface.
